(19) United States
(12) Patent Application Publication
(10) Pub. No.: US 2022/0184889 A1
(43) Pub. Date: Jun. 16, 2022

(54) ADDITIVE MANUFACTURING MACHINES COMPRISING FOCUSED AND UNFOCUSED ENERGY SOURCES

(71) Applicant: HEWLETT-PACKARD DEVELOPMENT COMPANY, L.P., Spring, TX (US)

(72) Inventors: Arthur H. Barnes, Vancouver, WA (US); Adam Franks, Grenoble, Isere (FR); Wesley R. Schalk, Vancouver, WA (US)

(21) Appl. No.: 17/595,336

(22) PCT Filed: Oct. 24, 2019
(86) PCT No.: PCT/US2019/057778

§ 371 Date: Nov. 15, 2021

(51) Int. Cl. B29C 64/282; B29C 64/236; B29C 64/205; B29C 64/393; B29C 64/153; B33Y 10/00; B33Y 30/00; B33Y 50/02

(52) U.S. Cl. CPC B29C 64/282; B29C 64/236; B29C 64/205; B33Y 50/02; B29C 64/153; B33Y 10/00; B33Y 30/00; B29C 64/393

(57) ABSTRACT

In some examples, an additive manufacturing machine includes an unfocused energy source to heat portions of a layer of build material as the unfocused energy source moves across the layer of build material during a build operation of a three-dimensional (3D) object. A focused energy source is controllable to selectively direct focused energy on the layer of build material during the build operation.

### BACKGROUND

Additive manufacturing machines produce three-dimensional (3D) objects by building up layers of build material, including a layer-by-layer accumulation and solidification of the build material patterned from computer aided design (CAD) models or other digital representations of physical 3D objects to be formed. A type of an additive manufacturing machine is referred to as a 3D printing system. Each layer of the build material is patterned into a corresponding part (or parts) of the 3D object.

### BRIEF DESCRIPTION OF THE DRAWINGS

Some implementations of the present disclosure are described with respect to the following figures.

FIG. 1 is a block diagram of an additive manufacturing machine according to some examples.

FIG. 2A-2C illustrate example positions of a fuser carriage and a dispenser carriage in an additive manufacturing machine including a focused energy source, according to some examples.

FIG. 3 is a flow diagram of a process according to some examples.

FIGS. 4 and 5 are block diagrams of additive manufacturing machines according to various examples.

FIG. 6 is a block diagram of a storage medium storing machine-readable instructions according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

In the present disclosure, use of the term “a,” “an”, or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

In some examples, a build material used by an additive manufacturing machine such as a 3D printing system can include a powdered build material that is composed of particles in the form of fine powder or granules. The powdered build material can include metal particles, plastic particles, polymer particles, ceramic particles, or particles of other powder-like materials. In some examples, a build material powder may be formed from, or may include, short fibers that may, for example, have been cut into short lengths from long strands or threads of material.

In some examples of additive manufacturing machines, as part of the processing of each layer of build material, liquid agents can be dispensed by liquid agent dispensers (such as through a printhead or another fluid dispensing device) to a layer of build material. Examples of liquid agents include a fusing agent (which is a form of an energy absorbing agent) that absorbs heat energy emitted from an energy source used in the additive manufacturing process. For example, after a layer of build material is deposited onto a build platform (or onto a previously formed layer of build material) in the additive manufacturing machine, a fusing agent with a target pattern can be deposited on the layer of build material. The target pattern can be based on an object model (or more generally, a digital representation) of the physical 3D object that is to be built by the additive manufacturing machine.

According to an example, a fusing agent may be an ink-type formulation, such as, for example, the fusing agent formulation commercially referred to as the V1Q60A “HP fusing agent” available from HP Inc. In further examples, a fusing agent may alternatively or additionally include an infrared light absorber, a near infrared light absorber, a visible light absorber, or an ultraviolet (UV) light absorber. Fusing agents can also refer to a chemical binding agent, such as used in a 3D printing system that forms objects using a metal or other type of build material.

Different 3D objects formed by additive manufacturing machines can have varying part geometries. Part geometries can vary between large solid features to tiny and thin fragile features. In additive manufacturing machines that dispense liquid agents, different liquid agents can be applied in a variety of ways to achieve target part qualities. The large number of combinations of part geometries and liquid agents can make fusing of 3D parts challenging in additive manufacturing machines that employ unfocused energy sources, such as heating lamps (e.g., quartz infrared halogen lamps). An unfocused energy source can irradiate a large area of a layer of build material, for heating portions of the layer of build material (particularly portions where fusing agents have been applied) to raise the temperature of the portions of the layer of build material above the melting temperature of the build material.

In some cases, using unfocused energy sources to heat powdered material may not provide sufficient melting time to enable robust bonding between adjacent portions of build material. In other cases, the use of unfocused energy sources can affect the surrounding areas of powder that should not be melted into the part. The unfocused energy sources may cause the temperature of the surrounding areas (portions on which no fusing agent is applied) of powder to agglomerate in a heated condition, which can cause partial fusing of the surrounding areas into a 3D part being built. These partially fused surrounding areas can form a cake of hardened powder that can render 3D part extraction and cleaning more time consuming.

Moreover, different portions of a layer of build material may be associated with parts having different geometries, which can lead to inconsistent control of temperatures in the different portions by the unfocused energy source. For example, if a portion of the layer of build material is not heated to above a melt temperature, weak and fragile features and other defects may appear in parts of the 3D object that is being built by an additive manufacturing machine.

Other types of additive manufacturing machines include those that employ focused or optically coherent energy sources, such as lasers. In this disclosure, optically coherent energy sources will also be considered as “focused energy sources.” Additive manufacturing machines that employ focused energy sources include Select Laser Sintering (SLS) systems. A laser can emit a laser beam with a controlled spot diameter, which heats up small portions of a layer of build material to create fused surfaces in a point by point fashion. Use of a laser to heat parts with large surface areas of a layer of build material can be time consuming, which can adversely affect overall throughput of an additive manufacturing machine in building a 3D object.

In accordance with some implementations of the present disclosure, an additive manufacturing machine employs both an unfocused energy source and a focused energy source in a build operation of a 3D object.

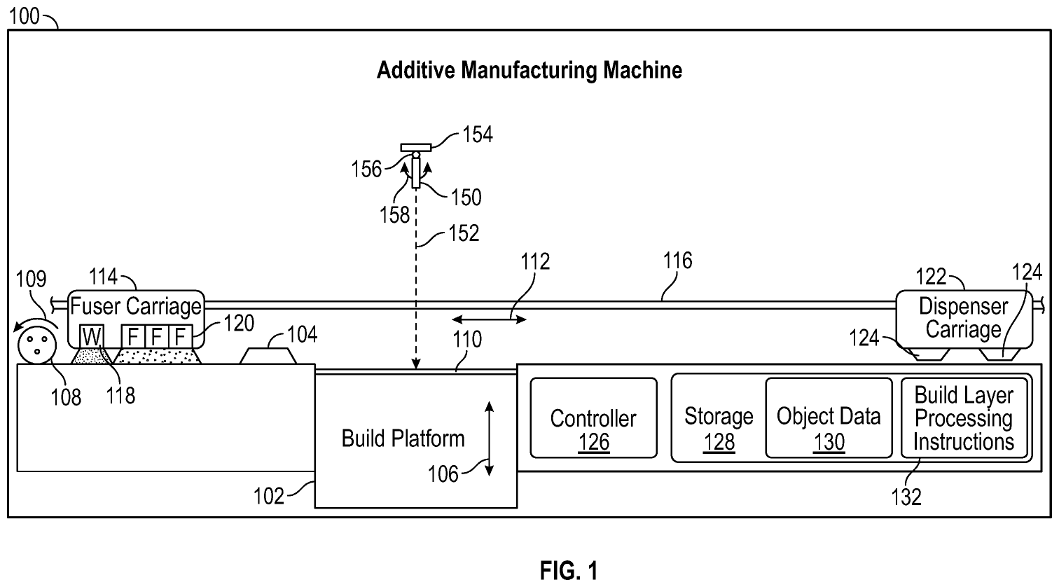

FIG. 1 is a block diagram of an additive manufacturing machine 100 according to some examples. The additive manufacturing machine 100 includes a build platform 102 having an upper surface on which a 3D object can be formed from a build material 104 on a layer-by-layer basis.

The build material can include any or some combination of a white build material, a non-white build material, a carbon-filled build material, an aluminum build material, or any other type of build material.

The build platform 102 is moveable in a vertical direction in the view of FIG. 1, as indicated by an axis 106. Parts of a 3D object can be formed in a layer-by-layer additive process within a 3D space (or build volume) that develops above the upper surface of the build platform 102, as the build platform 102 moves vertically downwardly during the additive process.

In some examples, the build material 104 can be contained in a cartridge, hopper, or other build material source (not shown) and can be delivered or deposited at a location next to or over the build platform 102 as a small pile of build material 104. The build material 104 can be spread or applied onto the build platform 102 or onto a previously formed build material layer by a spreader 108 to form a new build material layer 110.

The build material layer 110 is spread onto a build bed. Initially, before the 3D build operation has started, the build bed includes the upper surface of the build platform 102. After build material layers have been spread over the build platform and processed on a layer-by-layer basis, then the build bed would include any previously formed part(s) of the 3D object based on the previously processed build material layer(s). More generally, a “build bed” refers to a structure onto which a build material layer can be spread for processing, where the structure can include just the upper surface of the build platform, or alternatively, can further include any previously formed part(s) of a 3D object.

In some examples, the spreader 108 includes a bidirectional spreader to spread the build material 104 bidirectionally across the build platform 102 along axis 112. In further examples, the spreader 108 is moveable along multiple different axes. The spreader 108 may include a counter-rotating roller (that rotates along rotational direction 109), a blade, or any other device that is able to spread the build material 104 over a build bed.

The spreader 108 can be mounted on or can be operationally coupled to a fuser carriage 114. The fuser carriage 114 is moveably supported on a rail 116 or any other support structure, to make one pass or multiple passes across the build platform 102.

In some examples, the fuser carriage 114 includes unfocused energy sources 118 and 120. The unfocused energy sources are also referred to as “scanning” unfocused energy sources since the unfocused energy sources 118 and 120 are scannable across the build platform 102 due to the movement of the fuser carriage 114. The unfocused energy sources can include a warming source 118 and a fusing source 120. In some examples, the unfocused energy sources 118 and 120 include heat lamps, such as halogen heat lamps (e.g., quartz infrared halogen lamps), light emitting diode (LED) arrays, vertical-cavity surface-emitting laser (VCSEL) arrays, CALROD (electrical tubular) heaters, and so forth.

In some examples, the warming source 118 can include a lamp that produces infrared energy and wavelengths between 1.5 and 4 microns. Also, in some examples, the fusing source 120 can produce energy in the near-IR range of 0.76 to 1.5 microns. Although specific example wavelengths are provided for the unfocused energy sources 118 and 120, it is noted that in other examples, the unfocused energy sources 118 and 120 can generate energy having other wavelengths.

The warming source 118 has a spectral power distribution targeted to generally warm non-printed powder, whereas the fusing source 120 has a spectral power distribution that is designed to be absorbed by fusing agents or other liquid agents deposited onto the build material layer 110.

Although FIG. 1 shows an example in which multiple unfocused energy sources are included in the fuser carriage 114, it is noted that in other examples, the fuser carriage 114 can include just one unfocused energy source.

During processing of the build material layer 110 over the build bed, the unfocused energy sources 118 and 120 can selectively apply energy (or can simultaneously apply energy) as the fuser carriage 114 passes over the build material layer 110 in either or both directions along the axis 112. In other examples, the warming source 118 may be statically mounted above the build bed rather than included in the fuser carriage 114.

The amount of energy applied to the build material layer 110 can be controlled by controlling the speed of the fuser carriage 114 as the fuser carriage 114 passes over the build material layer 110. In further examples, the amount of energy applied to the build material layer 110 can be controlled by controlling the radiant power output and/or the wavelength of light emitted from either or both the unfocused energy sources 118 and 120. Also, in some examples, energy can be applied to the build material layer 110 in a number of successive passes of the fuser carriage 114 over the build material layer 110, to maintain selected portion(s) of the build material layer 110 above a melting temperature of the build material while maintaining other portion(s) of the build material layer 110 below the melting temperature.

In accordance with some implementations of the present disclosure, the additive manufacturing machine 100 further includes a focused energy source 150. Although just one focused energy source 150 is shown in FIG. 1, in other examples, multiple focused energy sources 150 can be provided. In some examples, the focused energy source 150 can include a laser, or alternatively, multiple lasers. A focused energy source 150 can also include an optically coherent energy source in some examples.

The focused energy source 150 is able to direct focused energy (in the form of electromagnetic light) towards a specific portion of the build material layer 110, such as indicated by arrow 152. The absorption of the light by the material of the specific portion of the build material layer creates heat. The emission of the targeted energy towards a target portion of the build material layer 110 (that is less than the entirety of the build material layer 110) is controlled such that the energy is emitted when the fuser carriage 114 and a dispenser carriage 122 are not obstructing the target portion of the build material layer 110.

In some examples, the focused energy source 150 can be pivotally mounted to a support structure 154, such as by a pivoting attachment mechanism 156. By being able to pivot along a rotational axis 158, the focused energy source 150 can be pointed towards different target portions of the build material layer 110, so that the focused energy source 150 can focus heat energy towards the different target portions. In such examples, even though the focused energy source 150 is stationary, the pivoting of the focused energy source 150 can direct energy in different directions.

In further examples, instead of or in addition to pivotally mounting the focused energy source 150 to the support structure 154, the support structure is also translatable (such as along an axis parallel to the axis 112 or along multiple different axes) to translate the focused energy source 150 to different positions so that the focused energy source 150 can emit targeted energy towards a target portion of the build layer 110.

The support structure 154 can be in the form of a plate or any other type of structure. The support structure 154 can be fixedly attached to a housing or other structure of the additive manufacturing machine 100, or alternatively, can be moveably attached to the housing or other structure of the additive manufacturing machine 100.

In some examples, the unfocused energy sources 118, 120 and the focused energy source 150 can be selectively activated and deactivated. In some examples, just the unfocused energy sources 118, 120 are activated during processing of the build material layer 110. In other examples, just the focused energy source 150 is activated during processing of the build material layer 110. In further examples, both the unfocused energy sources 118, 120 and the focused energy source 150 can be activated (either simultaneously or at different times) during processing of the build material layer 110.

In some examples, the focused energy source 150 may be used in some scenarios for building 3D parts with improved properties (e.g., less fragile, better bonding between different portions of the 3D object, etc.).

For example, the focused energy source 150 may be activated when building parts with relatively small features, such as features with dimensions below 1 millimeter (mm) for example, in any of the X, Y, or Z dimensions.

In further examples, the focused energy source 150 may be activated when forming the perimeters (outer boundary) of 3D parts.

The use of the focused energy source 150 may be useful in other scenarios.

In some examples, the additive manufacturing machine 100 includes a controller 126 to control various operations of the additive manufacturing machine 100 to form 3D parts.

As used here, a “controller” can refer to a hardware processing circuit, which can include any or some combination of a microprocessor, a core of a multi-core microprocessor, a microcontroller, a programmable integrated circuit, a programmable gate array, a digital signal processor, or another hardware processing circuit. Alternatively, a “controller” can refer to a combination of a hardware processing circuit and machine-readable instructions (software and/or firmware) executable on the hardware processing circuit.

The controller 126 can be used to perform selective activation and deactivation of the unfocused energy sources 118, 120 and the focused energy 150. The application of focused and unfocused energies can be determined and controlled by the controller 126 based on information, including object data 130 and build layer processing instructions 132 stored in a storage medium 128.

The object data 130 can represent, as examples, object files defining 3D object models to be produced by the additive manufacturing machine 100. The object data 130 can include build material-type definitions and related information such as melting temperature ranges for different types of build materials.

The build layer processing instructions 132 are executable by the controller 126 to generate print data for each cross-directional slice of a 3D object model from the object data 130. The print data can define, as examples, each cross-sectional slice of a 3D object model, the liquid agent(s) to be used to cover the build material layer 110 within each cross-sectional slice, and how fusing and warming energy is to be applied (from either or both focused and unfocused energy sources) to the build material layer 110 to maintain the build material layer 110 at different temperatures according to the type of build material being used within the build material layer 110. The print data can also include, as examples, the speed of the fuser carriage 114, the energy intensity and wavelengths for the unfocused and focused energy sources, the number of carriage passes to make over the build bed to maintain proper temperature in the build material layer 110, and so forth.

The storage medium 128 can be implemented using persistent storage device(s) (e.g., a solid state memory, a disk-based storage device, etc.) and/or volatile storage device(s) (e.g., a dynamic random access memory (DRAM) device, static random access memory (SRAM) device, etc.).

In addition to being able to control the selective activation or deactivation of the focused energy source 150, the controller can, based on the print information, control the focused energy source 150 to selectively emit focused energy at different wavelengths. The controller 126 can control the wavelength of the energy (light) emitted by the focused energy source 150 (e.g., a laser) based on the spectral absorption characteristic of a liquid agent dispensed onto a portion of the build material layer 110.

Some liquid agents can absorb more energy at a first wavelength of heat energy than at a second wavelength of heat energy. The print information can include information on the type of liquid agent being used in a particular portion of the build material layer 110, and the controller 126 can use such information to select the wavelength of the heat energy emitted by the focused energy source 150. In some cases, the print information can further include the desired wavelength of heat energy for the liquid agent used, and the controller 126 can use this information regarding the desired wavelength of heat energy to control the focused energy source 150 to emit the desired wavelength, or substantially close to the desired wavelength (e.g., within a specified range of the desired wavelength).

In some examples, the wavelength(s) of the energy emitted by the focused energy source 150 is matched by design to spectral absorption characteristic(s) of the fusing agent(s), and/or the spectral absorption characteristic(s) of the build material without liquid agent(s).

FIG. 1 further shows a dispenser carriage 122 that can move in bidirectional directions along the axis 112 (or along more than two directions). In some examples, the dispenser carriage 122 is also moveable along the rail 116 (or along a different rail)

The dispenser carriage 122 includes a liquid agent dispenser 124 (or multiple liquid agent dispensers) for dispensing liquid agents onto selected portions of the build material layer 110 as the dispenser carriage 122 moves across the build material layer 110. Each liquid agent dispenser 124 includes an array of nozzles that can extend along a width of the build material layer 110 (where the width extends in the direction into the page of FIG. 1 and is perpendicular to the axis 112). The nozzles include orifices through which liquid agents can be dispensed.

A liquid agent can include a fusing agent that acts as an energy absorber to facilitate heating of portions of the build material layer 110, when exposed to heat produced by either or both of an unfocused energy source (e.g., 118, 120) and the focused energy source 150.

In some examples, the liquid agent dispenser 124 can be in the form of a printhead, such as a thermal printhead or piezoelectric printhead. With a thermal printhead, thermal resistive elements are provided in the printhead, where the thermal resistive elements when activated produce heat that can cause ejection of liquid droplets from the nozzles of the liquid agent dispenser 124. The piezoelectric printhead includes piezoelectric elements that are mechanically deflected in response to activation to cause ejection of liquid agent droplets from the nozzles of the liquid agent dispenser 124.

In addition to controlling the energy sources (118, 120, 150), the controller 126 can control other components and operations of the additive manufacturing machine 100 according to the print data (130, 132) stored in the storage medium 128. Such other components and operations include movement of the fuser carriage 114, movement of the dispenser carriage 122, movement of the spreader 108, activation of the liquid agent dispenser 124, and so forth.

During a build operation for each build material layer 110, the fuser carriage 114 and the dispenser carriage 122 can be moved over the build material layer 110 over multiple passes in the two directions along axis 112.

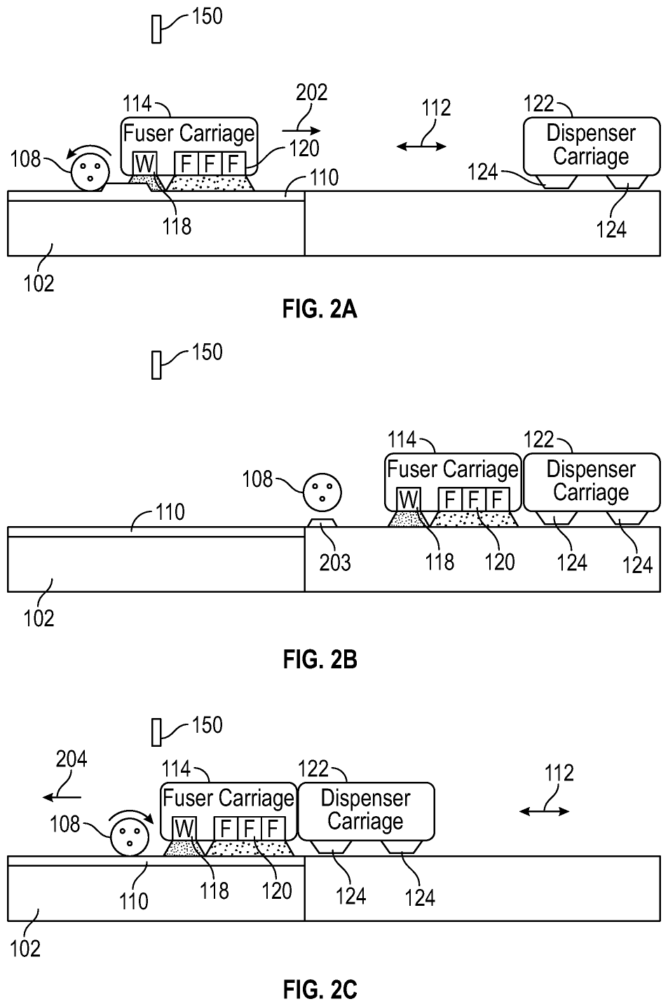

FIGS. 2A-2C illustrate three example positions of the fuser carriage 114 and the dispenser carriage 122. Note that there can be several other positions of the fuser carriage 114 and the dispenser carriage 122 that are not shown in FIGS. 2A-2C.

As shown in FIG. 2A, the fuser carriage 114 is controlled to move in a direction 202 (left to right in the view of FIG. 2A). During the translation of the fuser carriage 114, the controller 126 can control activation of the unfocused energy sources 118, 120 as the fuser carriage 114 is moved in the direction 202, to heat portions of the build material layer 110. The focused energy source 150 can also be activated to emit energy towards targeted portion(s) of the build material layer 110 when the fuser carriage 114 is not obstructing the targeted portion(s) of the build material layer 110.

The spreader 108 is coupled to, or is part of, the fuser carriage 114, and moves with the fuser carriage 114 in the direction 202. The movement of the spreader 108 in the direction 202 spreads the build material across the build bed.

FIG. 2B shows the fuser carriage 114 moved towards its rightmost position, and is positioned next to the dispenser carriage 122. At this point, in some examples a pile of build material 203 can be present on the right of the build bed in the view of FIG. 2B. The spreader 108 can be lifted up over the pile of build material 203, and put down on the right side of the pile of build material 203 in preparation for spreading the pile of build material 203 back over the build bed.

As shown in FIG. 2C, both the fuser carriage 114 and the dispenser carriage 122 move over the build bed in a direction 204, which is opposite the direction 202 of movement shown in FIG. 2A. The spreader 108 can perform further spreading of the build material as the spreader 108 also moves in the direction 204.

When the dispenser carriage 122 moves over the build material layer 110, the liquid agent dispenser 124 can be activated to dispense a liquid agent onto portion(s) of the build material layer 110.

In either or both of FIG. 2B or 2C, the controller 126 can activate the focused energy source 150 to heat selected portion(s) of the build material layer 110.

The fuser carriage 114 and the dispenser carriage 122 can be moved back and forth in both directions along axis 112, and the unfocused and focused energy sources are selectively activated, in multiple passes for processing each build material layer.

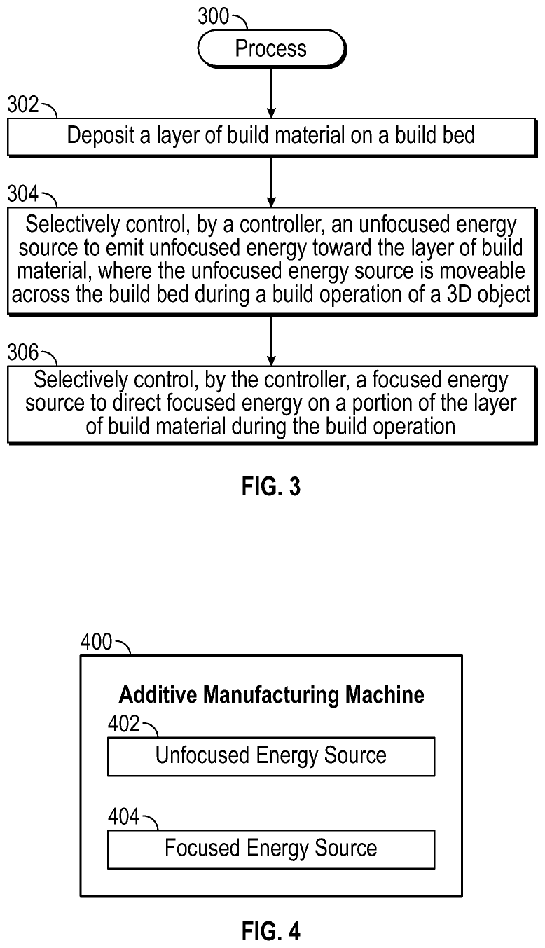

FIG. 3 is a flow diagram of a process 300 according to some examples, where the process 300 is performed in an additive manufacturing machine (e.g., 100 in FIG. 1).

The process 300 includes depositing (at 302) a layer of build material on a build bed (either an empty upper surface of a build platform or a previously formed 3D part).

The process 300 includes selectively controlling (at 304), by a controller (e.g., 126 in FIG. 1), an unfocused energy source (e.g., 118 and/or 120 in FIG. 1) to emit unfocused energy toward the layer of build material. The unfocused energy source is moveable (such as on the fuser carriage 114 of FIG. 1) across the build bed during a build operation of a 3D object.

The process 300 includes selectively controlling (at 306), by the controller, a focused energy source (e.g., 150 in FIG. 1) to direct focused energy on a portion of the layer of build material during the build operation.

By being able to selectively use the focused energy source in addition to the unfocused energy source in the additive manufacturing machine, 3D parts built by the additive manufacturing machine can have better quality due to superior temperature control, especially for parts with small features or for perimeters of parts, for example.

In addition, the focused energy source can be used to apply heat energy at targeted portion(s) of the build material layer between passes of the fuser carriage, to prevent drops in temperature of the targeted portion(s). The controller 126 can analyze the object data 130 to identify features within each build material layer 110 that are under a specified size (e.g., 1 mm in any of the X, Y, or Z dimension), or to identify features at perimeters (outer boundary) of 3D parts. These perimeters can be flagged, so that the controller 126 can deliver additional heat using the focused energy source 150 to portions of the build material layer 110 including the features.

Gloss level and surface finish of a 3D part built by the additive manufacturing machine can be varied by adjusting energy delivery from the unfocused and focused energy sources due to improved control of the melt pool viscosity and material coalescence. Gloss level is determined by the degree of material coalescence on the part surface. Higher gloss levels are attained by providing energy delivery that reduces the material viscosity in the melt pool so that individual particles of build material can flow and remove any interstitial spaces or voids. The controller 126 can determine based on the object data 130 portions of the build material layer 110 associated with a “high gloss” property so that targeted energy from the focused energy source 150 can be provided.

As another example, the color of a feature to be built can be considered by the controller 126 when using the focused energy source 150. This would enable fusing parts with colors matching the un-fused build material, for example. Liquid agents tend to create a slight tint on the surface color.

More generally, the controller 126 can determine, based on data representing the 3D object (e.g., the object data 130), a property of a feature to be formed in the build material layer 110. For example, the property is selected from among a size of the feature, a location (e.g., perimeter or interior) of the feature, a gloss level of the feature, and/or a color of the feature. The controller 126 controls the focused energy source 150 to direct the focused energy to a portion of the build material layer 110 based on the determined property.

FIG. 4 is a block diagram of an additive manufacturing machine 400 that include an unfocused energy source 402 to heat portions of a layer of build material as the unfocused energy source moves across the layer of build material during a build operation of a 3D object. The additive manufacturing machine 400 includes a focused energy source 404 controllable to selectively direct focused energy on the layer of build material during the build operation.

The focused energy source 404 can direct the focused energy on a first portion of the layer of build material, and not direct energy at a second portion of the build material.

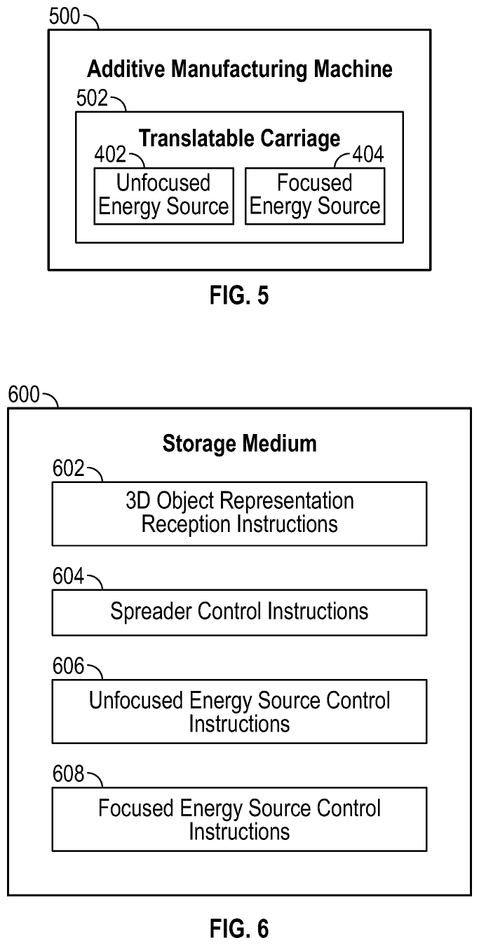

In some examples, as shown in FIG. 5, an additive manufacturing machine 500 includes the unfocused energy source 402 and the focused energy source 404, in addition to a translatable carriage 502 (e.g., fuser carriage 114 in FIG. 1) to carry the unfocused energy source 402 across a build bed as the carriage moves along a direction of travel.

As further shown in FIG. 5, the focused energy source 404 in some examples can be part of the carriage 502. In other examples, the focused energy source 404 can be separate from the carriage 502, such as in the example of FIG. 1.

FIG. 6 is a block diagram of a non-transitory machine-readable or computer-readable storage medium 600 storing machine-readable instructions that upon execution cause a controller of an additive manufacturing machine to perform various tasks.

The machine-readable instructions include 3D object representation reception instructions 602 to receive a representation of a 3D object to be built by the additive manufacturing machine.

The machine-readable instructions further include spreader control instructions 604 to, based on the representation of the 3D object, control a spreader to spread a layer of build material on a build bed.

The machine-readable instructions further include unfocused energy source control instructions 606 to, based on the representation of the 3D object, control an unfocused energy source to emit unfocused energy toward the layer of build material.

The machine-readable instructions further include focused energy source control instructions 608 to, based on the representation of the 3D object, control a focused energy source to direct focused energy on a portion of the layer of build material during the build operation.

The storage medium 600 can include any or some combination of the following: a semiconductor memory device such as a dynamic or static random access memory (a DRAM or SRAM), an erasable and programmable read-only memory (EPROM), an electrically erasable and programmable read-only memory (EEPROM) and flash memory; a magnetic disk such as a fixed, floppy and removable disk; another magnetic medium including tape; an optical medium such as a compact disc (CD) or a digital video disc (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. An additive manufacturing machine comprising:
an unfocused energy source to heat portions of a layer of build material as the unfocused energy source moves across the layer of build material during a build operation of a three-dimensional (3D) object; and
a focused energy source controllable to selectively direct focused energy on the layer of build material during the build operation.

2. The additive manufacturing machine of claim 1, wherein the focused energy source is to direct the focused energy or a first portion of the layer of build material, and is to not direct energy at a second portion of the build material.

3. The additive manufacturing machine of claim 1, further comprising:
a translatable carriage to carry the unfocused energy source across a build bed as the carriage moves along a direction of travel.

4. The additive manufacturing machine of claim 3, further comprising a spreader coupled to the carriage and to move with the carriage to spread the build material onto the build beds.

5. The additive manufacturing machine of claim 3, wherein the focused energy source is part of the carriage.

6. The additive manufacturing machine of claim 1, further comprising a controller to:
determine, based on data representing the 3D object, a property of a feature to be formed in the layer of build material, the property selected from among a size of the feature, a location of the feature, a gloss level of the feature, or a color of the feature; and
control the focused energy source to direct the focused energy to a portion of the layer of build material based on the determined property.

7. The additive manufacturing machine of claim 1, wherein the focused energy source is to selectively emit focused energy at different wavelengths.

8. The additive manufacturing machine of claim 6, further comprising a controller to:
select a first wavelength from the different wavelengths based on a property of a first liquid agent applied to the layer of build material, and
control the focused energy to emit the focused energy at the selected first wavelength.

9. The additive manufacturing machine of claim 7, wherein the controller is to:
select a second wavelength from the different wavelengths based on a property of a second liquid agent applied to another layer of build material, and
control the focused energy to emit a focused energy at the selected second wavelength.

10. The additive manufacturing machine of claim 1, wherein the focused energy source is stationary or moveable relative to the layer of build material.

11. The additive manufacturing machine of claim 1, wherein the focused energy source is to fuse the layer of build material selected from among a white build material, a non-white build material, a carbon-filled build material, or an aluminum build material.

12. A method comprising:
depositing a layer of build material on a build bed;
selectively controlling, by a controller, an unfocused energy source to emit unfocused energy toward the layer of build material, the unfocused energy source moveable across the build bed during a build operation of a three-dimensional (3D) object; and
selectively controlling, by the controller, a focused energy source to direct focused energy on a portion of the layer of build material during the build operation.

13. The method of claim 12, comprising:
determining, based on data representing the 3D object, a property of a feature to be formed in the layer of build material, the property selected from among a size of the feature, a location of the feature, a gloss level of the feature, or a color of the feature; and
control the focused energy source to direct the focused energy to a portion of the layer of build material based on the determined property.

14. A non-transitory machine-readable storage medium comprising instructions that upon execution cause a controller of an additive manufacturing machine to:
receive a representation of a three-dimensional (3D) object to be built by the additive manufacturing machine;
based on the representation of the 3D object:
control a spreader to spread a layer of build material on a build bed;
control an unfocused energy source to emit unfocused energy toward the layer of build material, the unfocused energy source moveable across the build bed during a build operation of the 3D object; and
control a focused energy source to direct focused energy on a portion of the layer of build material during the build operation.

15. The non-transitory machine-readable storage medium of claim 14, wherein the instructions upon execution cause the controller to:
select a first wavelength from different wavelengths based on a property of a first liquid agent applied to a first layer of build material;
control the focused energy to emit the focused energy at the selected first wavelength toward the first layer of build material;
select a second wavelength from the different wavelengths based on a property of a second liquid agent applied to a second layer of build material;
control the focused energy to emit the focused energy at the selected second wavelength toward the second layer of build material.
